(19) United States
(12) Patent Application Publication
(10) Pub. No.: US 2005/0246515 A1
(43) Pub. Date: Nov. 3, 2005

(54) Method for the coding/decoding of vliw cached instructions

(76) Inventors: Helge Betzinger, Dresden (DE); Yuyi Tang, Munich (DE)

Correspondence Address: BAKER & BOTTS, 30 ROCKEFELLER PLAZA, NEW YORK, NY, 10112, US

(21) Appl. No.: 10/516,675

(22) PCT Filed: May 28, 2003
(86) PCT No.: PCT/DE03/01748

§ 371 Date: Jun. 22, 2005

(30) Foreign Application Priority Data
Jun. 5, 2002 (DE) 102 25 099.5

(51) Int. Cl. G06F 15/00; G06F 15/76

(52) U.S. Cl. 712/24

(57) ABSTRACT

A method for controlling functional units in a processor is provided. During a configuration phase of the processor, a series of primary instruction words from the translation of a programme code are subjected to a division into series of instruction word bits. By this, the instruction words controlling the processor during a programme execution are generated with a full instruction word size and buffered in an instruction word memory (cache). The method improves the processor performance in the execution phase by increasing the degree of compression of the primary instruction words into divided instruction word bits. This is acheived independent of special features such as periodicity of the Function Instruction Word bit. First during the configuration phase, a division of a primary instruction word into a Tagged Very Long Instruction Word occurs. Next, this Tagged Very Long Instruction Word is transformed into a Headed Very Long Instruction Word, which includes a general header. The transformed Word has a code-compressed structure and replaces all functions of the Tagged Very Long Instruction Word.

### CROSS REFERENCE TO RELATED APPLICATIONS

This application claims the benefit of International Patent Application No. PCT/DE03/01748 filed Dec. 5, 2003, which claims priority to German Patent Application No. DE20021025099 filed Jun. 5, 2002, both of which applications are hereby incorporated by reference herein in their entireties.

### FIELD OF THE INVENTION

The invention relates to the structure and operation of a processor. In particular, the invention relates to a method for actuating function units in a processor.

### BACKGROUND OF THE INVENTION

In some processors, a configuration phase involves a series of primary instruction words that comes from a translation of a program code being divided into a series of instruction word parts, and a program cycle which actuates the processor subsequently involving instruction words that are generated in the full instruction word length as a VLIW (Very Long Instruction Word) and are buffer-stored in an instruction word memory (cache).

To this end, various solutions are known which deal with a respective advantageous variant for the synthesis of a VLIW (very Long Instruction Word) from the instruction words which arise during the program cycle.

A common feature of these solutions is that the primary instruction words resulting from a translation of the program code are generated as a series of divided instruction word parts.

A current VLIW is thus constructed from a limited number of function instruction words (FIW), each of these FIWs actuating precisely one function unit (FU) in the processor.

German patent specification DE 198 59 389 C1 characterizes the prior art for methods of the type mentioned at the outset.

In the case of this solution, the primary instruction words which are present in the program are divided into individual program words, which are also advantageously referred to as TVLIW (Tagged Very Long Instruction Word) containers.

They are called TVLIW containers because the individual program word is made up not only of an information part, which is represented primarily by an FIW (Function Instruction Word), but also the details regarding the write and read row numbers of an instruction word memory which is to be used. The latter details represent a tag for the FIW.

In addition, the program word also includes the details regarding how to handle the respective content of the instruction word memory characterized in this manner, and these are thus represented by an operating code (Opcode).

In the case of the aforementioned method, the data length of the program to be processed in the processor is advantageously reduced in order to keep down the hardware complexity and hence the costs for implementing the respective processor.

In addition, various solutions are known which with a respective advantageous variant for synthesis of a VLIW (Very Long Instruction Word) the FIWs which arise during the program cycle.

Hence, the printed document 102 03 541.5 for the German patent application outlines the continuing prior art.

In the case of this prior art, the division of the primary instruction words which is carried out in a configuration phase is expanded by a subsequent methodological automatic similarity analysis, the result of which is that the instruction word parts which have been selected with particular similarity features (periodic property) and hence can be used repeatedly are combined.

This series of instruction word parts is used in the subsequent processing phase to produce the VLIW with an operating code which is common in this regard and a flag (which is valid for all members of the series) for its periodic property which has the number of members added to it.

In this way, this specific compression operation involves the performance, in the configuration phase, of the selection and flagging of the instruction word parts which are provided for buffer-storage in the execution phase and hence save processor performance when the same instruction word parts are reused.

With the increasing complexity of the processors and the demands on the processing speed, it becomes clear that it is necessary to achieve a higher level of compression when coding the instruction word parts and decoding them in order to produce the VLIW (Very Long Instruction Word), since increasing the processing speed in another way, e.g. by increasing the operating clock frequencies, hits physical boundaries.

Consideration is now being given to ways of increasing the processor performance during the execution phase by increasing the level of compression of the primary instruction words into their divided instruction word parts regardless of specific features (periodicity) of the FIWs.

### SUMMARY OF THE INVENTION

In accordance with the principles of the invention, procedures are provided for actuating function units in a processor.

An exemplary procedure has a first step involving a primary instruction word being divided, in the configuration phase, into the series of a particular number of instruction word parts which are used for constructing a respective VLIW during the execution phase.

In this case, a respective first and second FIW (Function Instruction Word part) is preceded with an associated first or second operating code. This thus determines how the cache's memory location taken up by the respective FIW is handled in the execution phase.

In addition, the respective first or second operating code is followed by an associated first or second tag which represents the information regarding which first or second FU actuates the respective FIW.

The first or second operating code and its associated first or second tag are respectively combined with the respective first and second FIWs to form the first and second TVLIW containers.

In this context, all of these represent the TVLIW.

A second step involves the respective available TVLIW being converted into an HVLIW in the configuration phase. A general header is put in front in the HVLIW.

When converting the TVLIW into the HVLIW, the latter with the code-compressed general header structure it contains replaces all functions of the TVLIW.

In one variant, the inventive object is achieved by implementing a “Command Code” mode of operation of the HVLIW and its associated general header. This general header stores the information, in coded form, which indicates all combinations regarding which first and second FIW (instruction word part) is provided, after decoding, in the execution phase, for actuating a respective first and/or second FU (function unit) in the processor.

In addition, the general header stores which first and/or second FIW takes up memory locations in the cache and whether or which operations are to be executed with the respective memory content in the execution phase in the cache when constructing the VLIW.

The aim of this solution is for the desired compression of the instructions to be implemented in the “Command Code” mode of operation of the HVLIW by combining a plurality of FIWs and an associated combination of the details regarding which of the FUs is to be actuated by which FIW, and also which FIW takes up particular memory locations in the cache when the VLIW is constructed and which operations are then executed with the memory content of said memory locations in relation to other memory locations in the cache.

This saves memory space and conserves processor performance.

One advantageous form of the variant of the inventive manner of achieving the object is achieved by virtue of the first part of the general header being provided with a header mode which contains information about the “Command Code” mode of operation of the HVLIW and of the general header.

This is followed by a second part which contains the respective most needed combination regarding which of the respective FUs is actuated by which first or second FIW.

This most needed combination is dictionary as a coded table value.

A third part is connected as CE information (Cache Extra information) and contains a pointer which refers to a provided location in the dictionary.

The last part of the general header which is provided is the supplementary information.

The general header is followed directly by the first and second FIWs needed for constructing the VLIW.

This inventive solution lays emphasis on “Command Mode” mode of operation with general header which is very flexible and types of “Command Code”. This is also providing the a structured supports all intended to remain valid for further development and updates and to safeguard its compression options.

A further variant of the inventive manner of achieving the object is for a “reference instruction” mode of operation of the general header to be implemented in which the FIWs provided for constructing the VLIW in the execution phase are buffer-stored generally in the cache.

In this context, the associated header mode bears a correspondingly decodable tag for this “reference instruction” mode of operation. The “reference instruction” mode of operation is specific HVLIW.

The latter contains an address statement which is used to refer to a reference instruction.

In addition, the subsequent HVLIW, which likewise bears the tag for the “reference instruction” mode of operation, contains a relative address for the address provided by the reference.

This has a mask appended to it which represents the FUs which are to be excluded from the actuation.

In the case of this beneficial variant of the inventive solution, the implementation of the specific “reference instruction” mode of operation of HVLIWs avoids the long instructions for the processor kernel, which turn out to be long even in the “Command Code” header mode, for example, because they need to be able to be used for a large number of FUs (Function Units).

As a result, respective start and end phases of the instructions are also required for actuating the basic constituents of the individual FUs.

On account of a large number of identical FIWs which are produced for actuating the FUs in the instructions, e.g. in digital signal processors (DSPs), it is obvious from knowledge of the instructions for the processor kernel that the respective start and end phases of the instructions are redundant for the respective FUs.

This redundancy is avoided by the inventive solution by virtue of the HVLIW which initiates the “reference instruction” mode of operation being used to prescribe an address statement as a reference.

In the subsequent HVLIW of the “reference instruction” mode of operation, said HVLIW's general header is used to communicate only a relative address statement which can be used to decode the necessary FIW in the execution phase.

After the general header, this HVLIW likewise indicates the first and/or second FU (function unit), for which this particular instruction is not intended to be used, in coded form.

As a mask, which excludes the actuation of FUs, this statement can be made much shorter than a statement of all FIWs which are to be actuated.

Hence, for HVLIWs, the respective start and end phases of the FIW intended for actuating the FUs provided need to be indicated only once in the general header in the “reference instruction” mode of operation. This saves memory space.

Since this compression does not require the respective complete start and end phases of the instructions to be processed during VLIW construction, the processor performance in the execution phase is consequently likewise under less of a strain as well.

One specific variant of the inventive manner of achieving the object which implements the “reference instruction” general header's mode of operation in locally beneficial fashion is for the specific HVLIW which initiates the “reference instruction” mode of operation to refer, as a contained address statement, to the preceding HVLIW.

One further specific variant of the inventive manner of achieving the object which implements the “reference instruction” general header's mode of operation in globally beneficial fashion is for the specific HVLIW which initiates the “reference instruction” mode of operation to refer, as a contained address statement, to a general address.

One advantageous extension to the manner of achieving the inventive object specifically for the “Command Code” mode of operation of the HVLIW is for the execution phase to involve the HVLIW being decoded in a decoder which is equipped with a header decoder, a CMDT (Command Code Decompression Table), a cache and a cache miss repair logic unit, the HVLIW being available in buffer-stored form.

The header decoder identifies the “Command Code” mode of operation of the general header from the header mode stored therein.

In addition, the identified header mode is taken as a basis for decompressing the values of the FU-C which are provided in the general header by means of a comparison with the CMDT and in conjunction with the CE information which is likewise taken from the general header.

The identified header mode taken as a basis for processing the supplementary information in the general header.

Possible incorrect access during buffer-storage in the cache (cache miss) is remedied by the execution of an error handling routine in the cache miss repair logic unit.

Finally, the valid VLIW is provided at the output of the decoder.

### BRIEF DESCRIPTION OF THE DRAWINGS

Further features of the invention, its nature, and various advantages will be more apparent from the following detailed description and the accompanying drawings, wherein like reference characters represent like elements throughout, and in which:

FIG. 1 is a schematic block diagram illustrating the steps of a procedure for actuating function units of a processor in accordance with in accordance with the principles of the present invention.

FIG. 2 is a schematic block diagram illustrating the steps of a procedure for actuating function units of a processor in accordance with in accordance with the principles of the present invention.

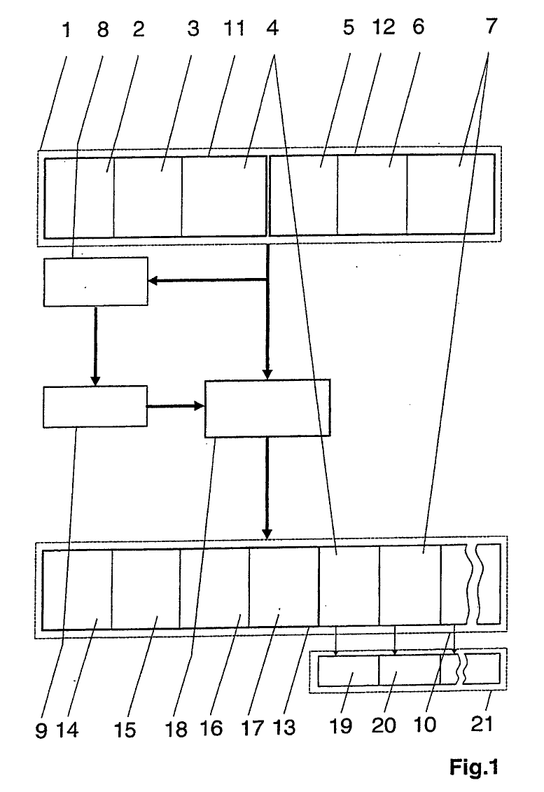

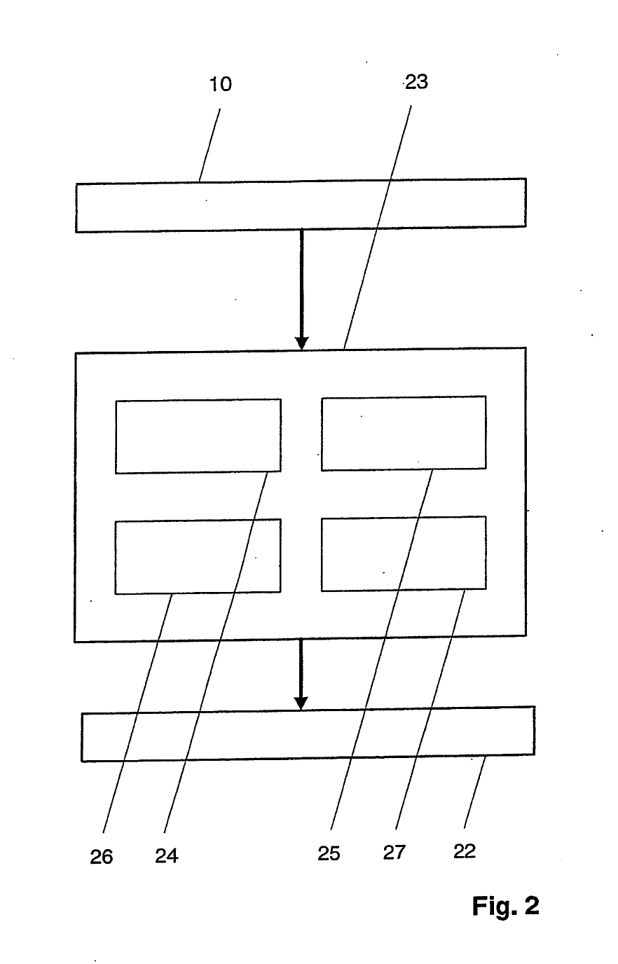

The following is a list of the reference numerals used in FIGS. 1 and 2:
1. TVLIW (jagged Very Long Instruction Word)
2. First operating code
3. First tag
4. First FIW (Function Instruction Word part)
5. Second operating code
6. Second tag Second FIW
7. Code analyzer
8. Dictionary
9. HVLIW (Headed Very Long Instruction Word)
10. First TVLIW container
11. Second TVLIW container
12. General header Header mode
13. FU-C information (Function Unit Combination information)
14. CE information (cache Extra information)
15. Supplementary information
16. Code converter
17. First FU (Function Unit)
18. Second FU (Function Unit)
19. Processor
20. VLIW (Very Long Instruction Word)
21. Decoder
22. Header decoder
23. CMDT (Command Code Decompression Table)
24. Cache
25. Cache miss repair logic unit

### DETAILED DESCRIPTION OF THE INVENTION

The present invention provides procedures for actuating function units of a processor.

An inventive procedure is described herein with reference to exemplary FIGS. 1 and 2.

FIG. 1 shows a block overview showing the compression steps which need to be executed in the configuration phase in order to convert the TVLIW 1 into the HVLIW 10 in the “Command Code” mode of operation.

FIG. 2 shows a block overview of the inventive decoder 23 that, during the execution phase, decompresses the compressed HVLIW 10 into the VLIW 22 in the “Command Code” mode of operation and decodes it, in order to actuate the processor 21.

As can be seen in FIG. 1, in the configuration phase the starting point for the inventive compression is the presence of the TVLIW 1. In an exemplary embodiment this comprises the first and second TVLIW containers 11; 12.

The respective first or second TVLIW container 11, 12 is available with its constituents: the first or second operating code 2, 5; the first or second tag 3, 6; and the first or second FIW 4, 7.

In the order which arises, a respective TVLIW container is supplied to a code converter 18 and at the same time a code analyzer 8 ascertains the combination of the three constituents of a TVLIW container in terms of the frequency of their occurrence in relation to the further TVLIW containers of the respective TVLIW by comparison with the details in a dictionary 9.

These details are made available to the code converter 18. The latter codes a general header 13 therefrom according to the mode of operation provided and logically combines it with the respective first or second FIW 4, 7, that are are taken from the first and second TVLIW containers 11, 12, provided in succession.

When all the TVLIW containers of the TVLIW 1 have been processed the structured general header 13 is provided and is available in the header mode 14, FU-C information 15, CE information 16 and supplementary information 17 parts. The general header 13 is put in front of the series of first and second FIWs 4, 7. A now complete HVLIW 10 is thus stored in the memory.

Subsequently, a further TVLIW 1 may be compressed.

The end of the inventive compression is reached when all of the TVLIWs 1 have been converted into a respective HVLIW 10.

As can be seen in FIG. 2, in the execution phase, the use of inventive decoder 23 for the decompressing/decoding the HVLIW 10 is triggered after the instructions have been buffer-stored (fetched) and hence upon provision of the HVLIW 10 and decoding of its header mode 14 using an available “Command Code” mode of operation.

Subsequently, the general header 13, as a constituent of the HVLIW 10, is buffer-stored in its constituents in the cache 26 and is decoded using the header decoder 24.

First, the first part of the general header 13, the header mode 14, is used to identify its mode of operation, and the decoder 23 is set accordingly.

The second part of the general header 13, the FU-C information 15, provides the information for the first and second FUs 19, 20 regarding which of the first and second FIWs 4; 7 need to be taken into account by the CMDT 25.

From the third part of the general header 13, the CE information, the area of the CMDT 25 which is to be taken into account is processed. The supplementary information 17 is taken from the last part of the general header 13.

Any incorrect access to the cache 26 which may be identified is remedied by the cache miss repair logic unit 27.

This information is used to construct the VLIW 22 by arranging the respective first and/or second FIWs 4, 7 in the VLIW 22 according to the decoded order and the position in which the first or second FU 19, 20 are subsequently actuated on the processor 21.

1-7. (canceled)

8. A method for actuating function units in a processor, wherein a configuration phase involves a series of primary instruction words that come from a translation of a program code being divided into a series of instruction word parts, with a program cycle involving instruction words which actuate the processor being constructed in the full instruction word length to form a VLIW and being buffer-stored in an instruction word memory (cache), the method comprising:
a first step that involves a primary instruction word being divided, in the configuration phase, into the series of a particular number of instruction word parts which are used for constructing a respective VLIW during the execution phase, with a respective first and second FIW (Function Instruction Word part), being preceded with an associated first or second operating code, which thus determines how the cache's memory location taken up by the respective FIW is handled in the execution phase,
wherein the respective first and second operating code are respectively followed by an associated first and second tag that represent the information regarding which of the first and the second FU actuates the respective FIW,
wherein the respective first and second operating code and their associated first or second tag are combined with the respective first and second FIWs to form the first and second TVLIW containers all of which represent the TVLIW; and
a second step that involves the respective available TVLIW being converted into an HVLIW in the configuration phase, wherein the HVLIW contains a preceding general header, and wherein the HVLIW with its code-compressed structure replaces all functions of the TVLIW.

9. The method of claim 1 wherein a Command Code mode of operation of the HVLIW and its associated general header is implemented so that the general header is followed directly by the first and second FIWs required for constructing the VLIW (22), wherein the general header stores the information in coded form, which indicates all combinations regarding which of the first and second FIW (instruction word part) is provided, after decoding in the execution phase for actuating a respective first and/or second FU (function unit) in the processor, and
wherein the general header stores which first and/ or second FIW take up memory locations in a cache and whether or which operations are to be executed with the respective memory content in the execution phase in the cache when constructing the VLIW.

10. The method of claim 1 wherein a first part of the general header is provided with a header mode that contains information about the “Command Code” mode of operation of the HVLIW and of the general header,
wherein the first part is followed by a second part that stores, coded as table values, the respective most needed combination regarding which of the respective FUs is actuated by which of the first and second FIW,
wherein a third part is connected as CE information and contains a pointer which refers to a provided location in a dictionary, and
wherein the last part of the general header provided is the supplementary information.

11. The method of claim 1 wherein a “reference instruction” mode of operation of the HVLIW and of the contained general header is implemented in which the FIWs provided for constructing the VLIW in the execution phase are buffer-stored in the cache, wherein the associated header mode bears a correspondingly decodable tag for this “reference instruction” mode of operation,
wherein the “reference instruction” mode of operation is initiated by a specific HVLIW that contains an address statement which is used to refer to a reference instruction,
wherein the subsequent HVLIW which likewise bears the tag for the “reference instruction” mode of operation, contains a relative address for the address statement provided by the reference, and
wherein a mask appended to it for the FUs which are to be excluded from the actuation.

12. The method of claim 4 wherein the address statement of the specific HVLIW which initiates the “reference instruction” mode of operation refers to a general address.

13. The method of claim 1 wherein the execution phase involves the HVLIW being decoded in a decoder which is equipped with a header decoder, a CMDT, a cache and a cache miss repair logic unit, wherein the HVLIW is buffer-stored in the cache, and wherein the header decoder identifies the mode of operation of the general header from the header mode stored therein,
wherein the identified header mode is taken as a basis for decompressing the values of the FU-C information which are provided in the general header by means of a comparison with the CMDT and in conjunction with the CE information which is likewise taken from the general header,
wherein the identified header mode is taken as a basis for processing the supplementary information in the general header, and
wherein possible incorrect access during buffer-storage in the cache (cache miss) is remedied by the execution of an error handling routine in a cache miss repair logic unit and a valid VLIW is provided at the output of the decoder.
